(19) United States
(12) Patent Application Publication
(10) Pub. No.: US 2024/0264031 A1
(43) Pub. Date: Aug. 8, 2024

(54) PASSIVE EXCITATION-BASED ONLINE CALIBRATION METHOD FOR BRIDGE STRUCTURE STRAIN MONITORING SYSTEM

(71) Applicant: RESEARCH INSTITUTE OF HIGHWAY MINISTRY OF TRANSPORT, Beijing (CN)

(72) Inventors: Genqiang JING, Beijing (CN); Lu PENG, Beijing (CN); Bing ZHANG, Beijing (CN); Hongbo GUO, Beijing (CN)

(21) Appl. No.: 18/564,990

(22) PCT Filed: Apr. 2, 2022
(86) PCT No.: PCT/CN2022/085158

§ 371 Date: Nov. 28, 2023

(30) Foreign Application Priority Data
Jun. 22, 2021 (CN) 202110689876.1

(51) Int. Cl. G01M 5/00

(52) U.S. Cl. CPC G01M 5/0041; G01M 5/0008

(57) ABSTRACT

A passive excitation-based online calibration method for a bridge structural monitoring system, comprising: taking a dynamic load of a normal passing vehicle of a bridge as a passive excitation source to act on a bridge structure; an RS and an SMS to be calibrated continuously and synchronously acquiring strain data of the bridge structure, and forming measurement data sequences according to time sequencing; calculating an instantaneous measurement error, a period measurement error, and a basic error of the SMS according to the measurement data sequences respectively acquired by the RS and the SMS to be calibrated; and taking the instantaneous measurement error, and/or the period measurement error, and/or the basic error as a calibration basis to perform online calibration on the metrology performance of the SMS.

### FIELD

The present disclosure relates to the technical field of bridge safety monitoring, in particular to a passive excitation-based online calibration method for a bridge structural monitoring system.

### BACKGROUND OF THE INVENTION

Strain monitoring is an important task in the health monitoring of structures of bridges, dams, high-rise buildings, etc. The metrology performance of a strain sensing system is an important safeguard for the accuracy of structural monitoring data, and is a fundamental precondition for a structural monitoring system to play its role in damage detection, performance assessment, safety warning, life prediction and the like.

Common sensors for strain monitoring include a fiber grating type strain gauge, a resistance type strain gauge, a vibrating wire type strain gauge, etc. The common principle is that structural strain measurement is converted into measurement on the strain of a sensing element itself by conduction of structural deformation, and then indirect measurement on the strain is achieved using the coupling relationship between the change in the length of the sensing element and a specific physical variable (e.g., optical wavelength, electrical resistance, inherent frequency, etc.).

The principle of strain measurement decides that the reliability of a monitoring result not only depends on the metrology performance of the sensor itself, but also is closely related to the fixed and tensioned state of the sensor. In order to meet the need for continuous acquisition of strain state variables throughout the life cycle of a bridge structure, sensors are retrospectively calibrated during their service lives, and also, the mounting states of the sensors cannot be arbitrarily changed. Therefore, an in-service structural monitoring system inevitably faces the problems of field environment, continuous monitoring, and online calibration under a passive excitation condition.

In the field of sensing system calibration methods, extensive research has been conducted over the last 20 years at home and abroad, and thus, certain paradigms have been developed. The basic idea is to build a traceability chain by comparison of simultaneous measurements of a measurement method and another measurement method under the action of specific excitation. An LMM (Levitation Mass Method) is a classical force sensor calibration method. According to the method, an inertial force is produced by driving a standard mass block to move through specific excitation sources, and an output force value is measured by a calibrated sensor. Meanwhile, the acceleration of the standard mass block is measured by a motion measuring system, and a standard force value is measured according to Newton's second law. Dynamic calibration of the force sensor is achieved by synchronous comparison of the output force value of the sensor and the standard force value. In this method, the excitation sources for driving the standard mass to move are mainly shock excitation, oscillation excitation, and step excitation. Research agencies, such as the Physikalisch-Technische Bundesanstalt (PTB), and the National Institute of Standards and Technology (NIST), have achieved dynamic calibration of force sensing systems by similar methods. The LMM does not affect the continuous normal operation of the calibrated system during implementation, is consistent with the actual requirements on the online calibration, but has harsh requirements on the operating conditions of the excitation sources and the measuring systems, and cannot meet the requirements of on-site online calibration.

Data analysis under external excitation conditions is an important technical measure for bridge structural state assessment. The bridge load test employs load-carrying vehicles to dynamically or statically load a bridge while monitoring a bridge structural response to achieve structural damage detection, performance assessment, load bearing capacity analysis, and the like. An Operational Modal Analysis (OMA) method based on structural vibration monitoring performs structural modal analysis by synthesizing response data of a bridge structure under environmental excitations, allowing bridge state assessment without interrupting traffic. At present, in structural performance studies for large bridges, using vehicle loads, environmental vibrations, or the like as the excitation conditions is still the most convenient and feasible test mode. However, because of the uncontrollability of the vehicle loads and the environmental conditions, online calibration based on such passive excitation will face multiple challenges in terms of theoretical models and implementation solutions.

### SUMMARY OF THE INVENTION

The present disclosure provides a passive excitation-based online calibration method for a bridge structural monitoring system based on the principle that convenience without interrupting normal traffic with respect to the problem of online calibration of a bridge structural monitoring system under an all-day working condition. According to the method, by taking the dynamic load of a normal passing vehicle on a bridge as an excitation condition, a calibration chain is established by synchronous measurement on structural response variables via an SMS (Structural Monitoring System) and an RS (Reference System), and quantitative characterization of online calibration characteristics is realized based on a metrological characteristic analysis model with large sample data.

To achieve this objective, the present disclosure employs the following technical solution.

A passive excitation-based online calibration method for a bridge structural monitoring system is provided, including the following steps:
1) taking a dynamic load of a normal passing vehicle on a bridge as a passive excitation source to act on a bridge structure;
2) acquiring strain data of the bridge structure by an RS and an SMS to be calibrated continuously and synchronously, and forming measurement data sequences according to time sequencing;
3) calculating an instantaneous measurement error, a period measurement error and a basic error of the SMS according to the measurement data sequences acquired by the RS and the SMS to be calibrated respectively; and
4) taking the instantaneous measurement error, and/or the period measurement error, and/or the basic error as a calibration basis to perform online calibration on the SMS.

Preferably, in the step 3), the instantaneous measurement error of the SMS is calculated by an equation (1) below:

$$Δ {d}_{S , i} = Δ {d}_{R , i} + Δ {d}_{S - R , i} - Δ {d}_{s p , i} - Δ {d}_{t m , i} \qquad equation ( 1 )$$

in the equation (1), Δd_{S,i} represents the instantaneous measurement error of the SMS in measuring strain of the bridge structure at an ith measurement moment;
Δd_{R,i} represents a measurement indication error of the RS in measuring strain of the bridge structure at the ith measurement moment;
Δd_{S-R,i} represents a difference between measurement indications of the SMS and the RS in measuring strain of the bridge structure at the ith measurement moment;
Δd_{sp,i} represents a difference between actual strain values of the bridge structure at mounting locations of the SMS and the RS on a bridge; and
Δd_{tm,i} represents a compensation value for measurement time differences of the SMS and the RS.

Preferably, Δd_{R,i} is calculated by an equation (2) below:

$$Δ {d}_{R , i} = {\tilde{q}}_{{i}^{″}} - {q}_{{i}^{″}} = {\tilde{q}}_{i} - ( {q}_{i} + {q}_{t , i} ) \qquad equation ( 2 )$$

in the equation (2), \tilde{q}_{i″} represents a measurement indication of the RS in measuring the strain of the bridge structure at an i″th measurement moment when an actual measurement moment of the ith measurement moment is the i″th measurement moment;
q_{i″} represents an actual strain value of the bridge structure at a mounting location of an RS sensor at the i″th measurement moment;
\tilde{q}ᵢ represents a measurement indication of the RS in measuring the strain of the bridge structure at the ith measurement moment;
qᵢ represents an actual strain value of the bridge structure at the mounting location of the RS sensor at the ith measurement moment; and
q_{t,i} represents a quantity of influence of the measurement time difference of the RS on accuracy of a strain measurement result of the bridge structure.

Preferably, Δd_{S-R,i} is calculated by an equation (3) below:

$$Δ {d}_{S - R , i} = {\tilde{p}}_{i} - {\tilde{q}}_{i} \qquad equation ( 3 )$$

in the equation (3), \tilde{p}ᵢ represents a measurement indication of the SMS in measuring the strain of the bridge structure at the ith measurement moment; and

\tilde{q}ᵢ represents a measurement indication of the RS in measuring the strain of the bridge structure at the ith measurement moment.

Preferably, Δd_{sp,i} is calculated by an equation (4) below:

$$Δ {d}_{sp , i} = {p}_{i} - {q}_{i} \qquad equation ( 4 )$$

in the equation (4), pᵢ represents an actual strain value of the bridge structure at a mounting location of an SMS sensor at the ith measurement moment; and
qᵢ represents the actual strain value of the bridge structure at the mounting location of the RS sensor at the ith measurement moment.

Preferably, Δd_{tm,i} is calculated by an equation (5) below:

$$Δ {d}_{t m , i} = {p}_{t , i} - {q}_{t , i} \qquad equation ( 5 )$$

in the equation (5), p_{t,i} represents a quantity of influence of the measurement time difference of the SMS on the accuracy of a strain measurement result of the bridge structure; and
q_{t,i} represents the quantity of influence of the measurement time difference of the RS on the accuracy of the strain measurement result of the bridge structure.

Preferably, the period measurement error of the SMS is calculated by an equation (6) below:

$$Δ {d}_{S} = Δ {d}_{S - R} + Δ {d}_{R} - Δ {d}_{sp} - Δ {d}_{t m} - Δ {d}_{T} + {δ}_{E} \qquad equation ( 6 )$$

in the equation (6), Ads represents the period measurement error of the SMS in measuring the strain of the bridge structure during online calibration;
Δd_{S-R} represents a difference between measurement indications of the SMS and the RS in measuring the strain of the bridge structure during online calibration;
Δd_{R} represents a measurement indication error of the RS in measuring the strain of the bridge structure during online calibration;
Δdₛₚ represents a difference between actual strain values of the bridge structure at the mounting locations of the SMS sensor and the RS sensor on the bridge;
Δdₜₘ represents a compensation value for the measurement time differences of the SMS and the RS during online calibration;
Δd_{T} represents a quantity of influence of an ambient temperature change on an assessment of a strain measurement indication error of the SMS during online calibration; and
δ_{E} represents a quantity of influence of excitation source characteristics and a data transmission process on an assessment of the strain measurement indication error of the SMS.

Preferably, Δdₛₚ is calculated by an equation (7) below:

$$Δ {d}_{sp} = ∇ d \cdot l \qquad equation ( 7 )$$

in the equation (7), ∇_{d} represents an actual strain gradient at mounting regions of the SMS sensor and the RS sensor during online calibration; and
l represents a mounting distance between the SMS sensor and the RS sensor.

Preferably, in the step 3), a method step of calculating the basic error includes:
3.1) matching data sequences that are measured by the SMS and the RS and have misalignments and scale differences, dividing the matched data sequences formed by measurement of the SMS and RS into N×N blocks based on the measured values and a data index, wherein coordinate locations of the blocks in a horizontal axis direction are used to specify a sequential order of data, and coordinate locations of the blocks in a vertical axis direction are used to determine calibration points;
3.2) taking edge blocks of the SMS and the RS as key blocks for fitting of a reference straight line, calculating mean values of data in the key blocks of the SMS and the RS to correspondingly form data sequences Y=y₁, y₂, . . . , y_{M} and X=x₁, x₂, . . . , x_{M}, wherein M represents a quantity of the key blocks of the SMS or the key blocks of the RS;
3.3) fitting Y and L according to a least square method to obtain the reference straight line for online calibration;
3.4) according to the reference straight line fitted in the step 3.3), taking a largest absolute value in an equation (8) or an equation (9) below as the basic error:

$${δ}_{{i}^{+}} = \frac{( {y}_{i +} - {Y}_{ofs + , i} ) - [ {Y}_{0} + K ( {L}_{{i}^{+}} - {L}_{ofs + , i} ) ]}{{Y}_{FS} + {Y}_{B}} \times 100 \% \qquad equation ( 8 )$$

$$i = 1 , 2 , … , M$$

$${δ}_{{i}^{-}} = \frac{( {y}_{i -} - {Y}_{ofs -} , ) - [ {Y}_{0} + K ( {L}_{{i}^{-}} - {L}_{ofs - , i} ) ]}{{Y}_{FS} + {Y}_{B}} \times 100 \% \qquad equation ( 9 )$$

$$i = 1 , 2 , … , M$$

wherein in the equation (8) or the equation (9), δᵢ₊ or δᵢ₋ represents the basic error;
yᵢ₊ and yᵢ₋ are respectively represent a maximum value and a minimum value of data in an ith key block in the key blocks of the SMS;
Lᵢ₊ and Lᵢ₋ are respectively represent a maximum value and a minimum value of data in an ith key block in the key blocks of the RS;
Y_{B} represents a height of each key block of the SMS;
K represents a constant;
Y_{FS} represents a difference between output values corresponding to a maximum input value and a minimum input value on the reference straight line;
Y_{ofs+,i} or Y_{ofs-,i} represents an increment for a monitoring value of the SMS introduced due to block division; and
L_{ofs+,i} or L_{ofs-,i} represents an increment for a monitoring value of the RS introduced due to block division.

Preferably, Y_{ofs+,i} is calculated by an equation (10) below:

$${Y}_{ofs + , i} = \{ \begin{matrix}{\overline{Y}}_{ofs +} \cdot \frac{( {Y}_{max , i} - {\overline{Y}}_{max} )}{( {\hat{Y}}_{max} - {\overline{Y}}_{max} )} , & {\hat{Y}}_{max} \neq {\overline{Y}}_{max} \\ {\overline{Y}}_{ofs +} , & {\hat{Y}}_{max} = {\overline{Y}}_{max}\end{matrix} \qquad equation ( 10 )$$

Y_{ofs-,i} is calculated by an equation (11) below:

$${Y}_{ofs - , i} = \{ \begin{matrix}{\overline{Y}}_{ofs -} \cdot \frac{( {Y}_{min , i} - {\overline{Y}}_{min} )}{( {\hat{Y}}_{min} - {\overline{Y}}_{min} )} , & {\hat{Y}}_{min} \neq {\overline{Y}}_{min} \\ {\overline{Y}}_{ofs -} , & {\hat{Y}}_{min} = {\overline{Y}}_{min}\end{matrix} \qquad equation ( 11 )$$

Y̅_{ofs+} in the equation (10) is calculated by an equation (12) below:

$${\overline{Y}}_{ofs +} = \frac{1}{M} {\sum }_{i = 1}^{M} ( {Y}_{max , i} - {Y}_{m ean , i} ) \qquad equation ( 12 )$$

Y̅_{ofs-} in the equation (11) is calculated by an equation (13) below:

$${\overline{Y}}_{ofs -} = \frac{1}{M} {\sum }_{i = 1}^{M} ( {Y}_{min , i} - {Y}_{m ean , i} ) \qquad equation ( 13 )$$

Y̅ₘₐₓ in the equation (10) is calculated by an equation (14) below:

$${\overline{Y}}_{max} = \frac{1}{M} {\sum }_{i = 1}^{M} {Y}_{max , i} \qquad equation ( 14 )$$

Ŷₘₐₓ is calculated by an equation (15) below:

$${\hat{Y}}_{max} = max ( {Y}_{max , i} ) \qquad equation ( 15 )$$

Y̅ₘᵢₙ in the equation (11) is calculated by an equation (16) below:

$${\overline{Y}}_{min} = \frac{1}{M} {\sum }_{i = 1}^{M} {Y}_{min , i} \qquad equation ( 16 )$$

Ŷₘᵢₙ is calculated by an equation (17) below:

$${\hat{Y}}_{min} = min ( {Y}_{min , i} ) \qquad equation ( 17 )$$

Y_{max,i} in the equations (10)-(17) represents a maximum value of the data in the ith key block of the SMS;
Y_{min,i} represents a minimum value of the data in the ith key block of the SMS;
Y_{mean,i} represents a mean value of the data in the ith key block of the SMS;

L_{ofs+,i} is calculated by an equation (18) below:

$${L}_{ofs + , i} = \{ \begin{matrix}{\overline{L}}_{ofs +} \cdot \frac{( {L}_{max , i} - {\overline{L}}_{max} )}{( {\hat{L}}_{max} - {\overline{L}}_{max} )} , & {\hat{L}}_{max} \neq {\overline{L}}_{max} \\ {\overline{L}}_{ofs +} , & {\hat{L}}_{max} = {\overline{L}}_{max}\end{matrix} \qquad equation ( 18 )$$

L_{ofs-,i} is calculated by an equation (19) below:

$${L}_{ofs - , i} = \{ \begin{matrix}{\overline{L}}_{ofs - ,} \cdot \frac{( {L}_{min , i} - {\overline{L}}_{min} )}{( {\hat{L}}_{min} - {\overline{L}}_{min} )} , & {\hat{L}}_{min} \neq {\overline{L}}_{min} \\ {\overline{L}}_{ofs -} , & {\hat{L}}_{min} = {\overline{L}}_{min}\end{matrix} \qquad equation ( 19 )$$

L̅_{ofs+} in the equation (18) is calculated by an equation (20) below:

$${\overline{L}}_{ofs +} = \frac{1}{M} {\sum }_{i = 1}^{M} ( {L}_{max , i} - {L}_{mean , i} ) \qquad equation ( 20 )$$

L̅_{ofs-} in the equation (19) is calculated by an equation (21) below:

$${\overline{L}}_{ofs -} = \frac{1}{M} {\sum }_{i = 1}^{M} ( {L}_{min , i} - {L}_{mean , i} ) \qquad equation ( 21 )$$

L̅ₘₐₓ in the equation (18) is calculated by an equation (22) below:

$${\overline{L}}_{max} = \frac{1}{M} {\sum }_{i = 1}^{M} {L}_{max , i} \qquad equation ( 22 )$$

\hat{L}ₘₐₓ is calculated by an equation (23) below:

$${\hat{L}}_{max} = max ( {L}_{max , i} ) \qquad equation ( 23 )$$

L̅ₘᵢₙ in the equation (19) is calculated by an equation (24) below:

$${\overline{L}}_{min} = \frac{1}{M} {\sum }_{i = 1}^{M} {L}_{min , i} \qquad equation ( 24 )$$

\hat{L}ₘᵢₙ is calculated by an equation (25) below:

$${\hat{L}}_{min} = min ( {L}_{min , i} ) \qquad equation ( 25 )$$

L_{max,i} in the equations (18)-(25) represents a maximum value of the data in the ith key block of the RS;
L_{min,i} represents a minimum value of the data in the ith key block of the RS;
L_{mean,i} represents a mean value of the data in the ith key block of the RS.

According to the present disclosure, by taking the dynamic load of the normal passing vehicle on the bridge as the excitation condition, a calibration chain is established by synchronous measurement on structural response variables via the SMS and the RS, and quantitative characterization of online calibration characteristics is realized based on a metrological characteristic analysis model of large sample data.

### BRIEF DESCRIPTION OF THE DRAWINGS

In order to more clearly illustrate technical solutions of embodiments of the present disclosure, drawings required to be used in the embodiments of the present disclosure will be briefly described below. Obviously, the drawings described below are only some embodiments of the present disclosure, and those of ordinary skill in the art may obtain other drawings can be obtained according to these drawings without creative efforts.

FIG. 1 is a diagram illustrating implementation steps of a passive excitation-based online calibration method for a bridge structural monitoring system according to an embodiment of the present disclosure;

FIG. 2 is a diagram illustrating steps of a method for calculating a basic error;

FIG. 3 is a schematic block diagram of an online calibrated bridge structural monitoring system;

FIG. 4 is a diagram illustrating spatial layout of an SMS sensor and an RS sensor on a bridge;

FIG. 5 is a diagram illustrating spatial layout of the SMS sensor and the RS sensor in an viewing angle A as shown in FIG. 4;

FIG. 6 is an analysis model for a data sequence for online calibration according to an embodiment of the present disclosure;

FIG. 7 is a schematic diagram illustrating a bridge structure response and an indication sequence at a mounting location of an SMS sensor;

FIG. 8 is a schematic diagram illustrating a bridge structure response and an indication sequence at a mounting location of an RS sensor;

FIG. 9 is a schematic diagram illustrating time and space differences measured by an SMS sensor and an RS sensor;

FIG. 10 is a schematic diagram illustrating a calibration curve; and

FIG. 11 is a schematic diagram illustrating data sequences for fitting of a reference straight line.

### DETAILED DESCRIPTION OF THE INVENTION

The technical solutions of the present disclosure are further illustrated below in combination with the drawings through specific embodiments.

The drawings are for illustrative purposes only, are shown in a schematic diagram form rather than in a real picture manner and are not to be construed as limiting this patent. In order to better describe the embodiments of the present disclosure, certain components in the drawings may be omitted, or may be exaggerated or reduced in size, which may not represent the actual product size. It will be understood by those skilled in the art that certain well-known structures and descriptions thereof in the drawings may be omitted.

Identical or similar reference numerals in the drawings of the embodiments of the disclosure correspond to identical or similar components. In the description of the present disclosure, it should be understood that if the orientation or positional relationship indicated by the terms “upper”, “lower”, “left”, “right”, “inner”, “outer” or the like is based on the orientation or positional relationship shown in the drawings, it is merely for facilitating the description of the present disclosure and simplifying the description, rather than indicating or implying that the indicated device or element must have, be constructed and operate in a particular orientation. Therefore, the terms used in the drawings to describe the positional relationship are for exemplary description only and are not to be construed as limiting this patent, and those of ordinary skill in the art can understand the specific meanings of the above terms according to specific circumstances.

In the description of the present disclosure, unless specifically stated and defined otherwise, the terms “connect” or the like for indicating a connection relationship between components should be understood broadly, for example, the connection may be fixed connection, may also be detachable connection, or may be integral connection; and the connection may be mechanical connection or electrical connection, may be direct connection or indirect connection through an intermediate medium, and may internal communication of two components or may refer to an interaction relationship of two components. Those of ordinary skill in the art can understand the specific meanings of the above terms in the present disclosure according to specific circumstances.

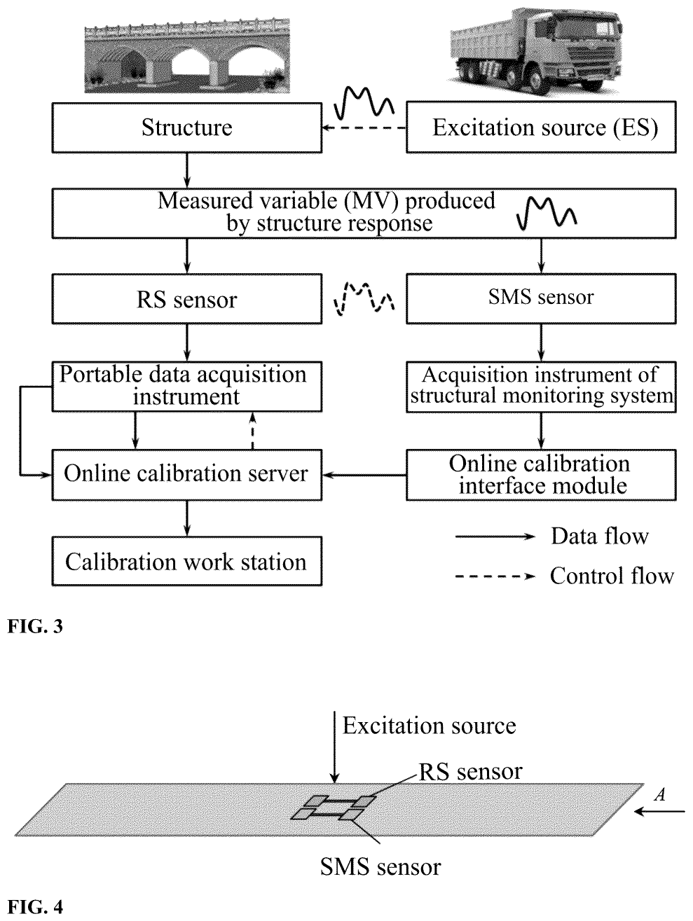

Online calibration of a structural monitoring system in service has multiple difficulties with respect to in-laboratory calibration particularly in complex on-site conditions where manual excitation sources are not preferred, and thus input excitation conditions are uncontrollable. The present disclosure provides online calibration for the structural monitoring system under the action of a passive excitation of a passing vehicle by an online calibration model in which the RS and the SMS to be calibrated perform synchronous measurement for comparison, wherein the principle is as shown in FIG. 3.

The calibration model is composed of four elements: a MV (Measured Variable), an ES (Excitation Source), an RS (Reference System), and an in-service SMS (Structural Monitoring System). Under normal traffic conditions, the combined loading effect (excitation source) of the passing vehicle acts on a bridge structure, creating strain locally in the structure. An SMS sensor and an RS sensor simultaneously measure strain variables and acquire measurement data sequences via acquisition instruments, wherein the RS sensor has been calibrated retrospectively and determined to have the accurate and stable measurement performance for use in providing reference values during online calibration. By means of this model, the SMS can be subjected to online calibration and metrology performance assessment under normal structural monitoring conditions by simply providing real-time strain monitoring data.

A passive excitation-based online calibration method for a bridge structural monitoring system provided by an embodiment of the present disclosure is specifically illustrated below.

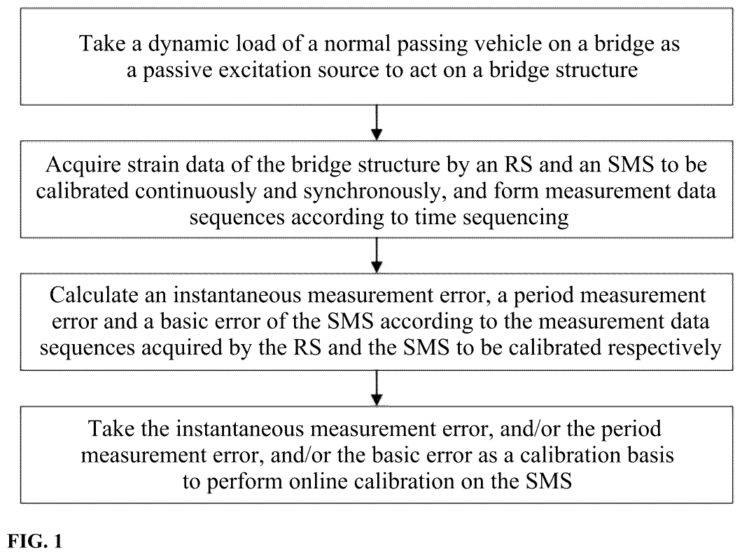

As shown in FIG. 1, the online calibration method includes the following steps:
1) using a dynamic load of a normal passing vehicle on a bridge as a passive excitation source to act on a bridge structure;
2) acquiring strain data of the bridge structure by an RS and an SMS to be calibrated continuously and synchronously, and forming measurement data sequences according to time sequencing;
3) calculating an instantaneous measurement error, a period measurement error and a basic error of the SMS according to the measurement data sequences acquired by the RS and the SMS to be calibrated respectively; and
4) calibrating the SMS online using the instantaneous measurement error, and/or the period measurement error, and/or the basic error as a calibration basis.

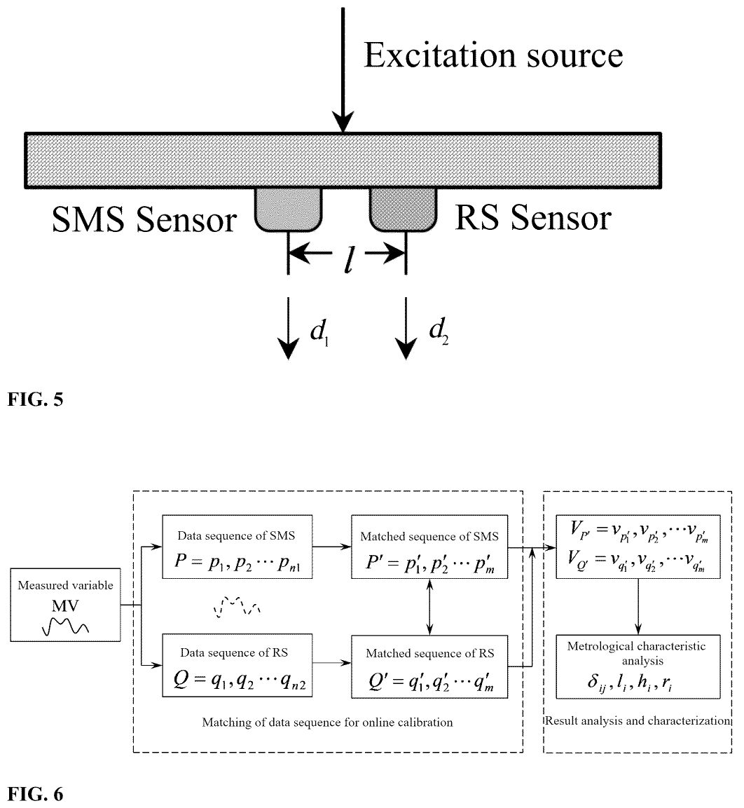

Amounting mode as shown in FIG. 4 and FIG. 5 is employed in order to ensure consistency of variables measured by the SMS sensor and the RS sensor. In the figures, the RS sensor and the SMS sensor are mounted side by side at short range to measure the same strain section of the bridge structure. The sensors are mounted in a direction consistent with a direction in which strain occurs to a beam.

Ideally, the SMS sensor and the RS sensor suffer from consistent strain responses at mounting locations. However, by taking into account the non-uniformity of the spatial distribution of the structural strain, and the differences in the measurement frequencies and time sequences of the SMS and the RS, the effects of time-space differences in the measured variables are incorporated into actual measurement sequences of the SMS and the RS, which serve as an element of a theoretical model for online calibration to be taken into account in the determination of uncertainty.

Data sequences acquired by measurement on the measured strain variables via the SMS and the RS are matched according to an analysis model as shown in FIG. 6 to analyze metrological characteristics of the SMS to be calibrated.

The strain response of a bridge is a time-varying signal with multiple frequencies superimposed under a combination of traffic load, ground pulsation, water current, wind power, and the like. Therefore, the data sequences measured by the SMS and the RS need to be matched to solve the problem of misalignments and scale differences, and the metrological characteristics are analyzed after synchronization and correspondence are achieved.

When the structural monitoring system is subjected to online calibrated, the SMS and the RS acquire strain monitoring data continuously and synchronously at respective set measurement frequencies, and the strain monitoring data are ranked based on time to form measurement data sequences. It is supposed that an actual strain value sequence of the structure at a mounting location of the SMS sensor is:

$$P = {p}_{1} , {p}_{2} , … {p}_{i} , … {p}_{n} \qquad ( 1 )$$

a measurement indication sequence of the SMS is:

$$\tilde{P} = {\tilde{p}}_{1} , {\tilde{p}}_{2} , … {\tilde{p}}_{i} , … {\tilde{p}}_{n} \qquad ( 2 )$$

In equations (1)˜(2), pᵢ and \tilde{p}ᵢ (i=1, 2, . . . n) are respectively a true value and an indication value measured by the SMS at an ith measurement moment.

Similarly, it is supposed that an actual strain value sequence at a mounting location of the RS is:

$$Q = {q}_{1} , {q}_{2} , … {q}_{i} , … {q}_{n} \qquad ( 3 )$$

a measurement indication sequence of the RS is:

$$\tilde{Q} = {\tilde{q}}_{1} , {\tilde{q}}_{2} , … {\tilde{q}}_{i} , … {\tilde{q}}_{n} \qquad ( 4 )$$

In equations (3)˜(4), qᵢ and \tilde{q}ᵢ (i=1, 2, . . . n) are respectively a true value and an indication value measured by the RS at the ith measurement moment.

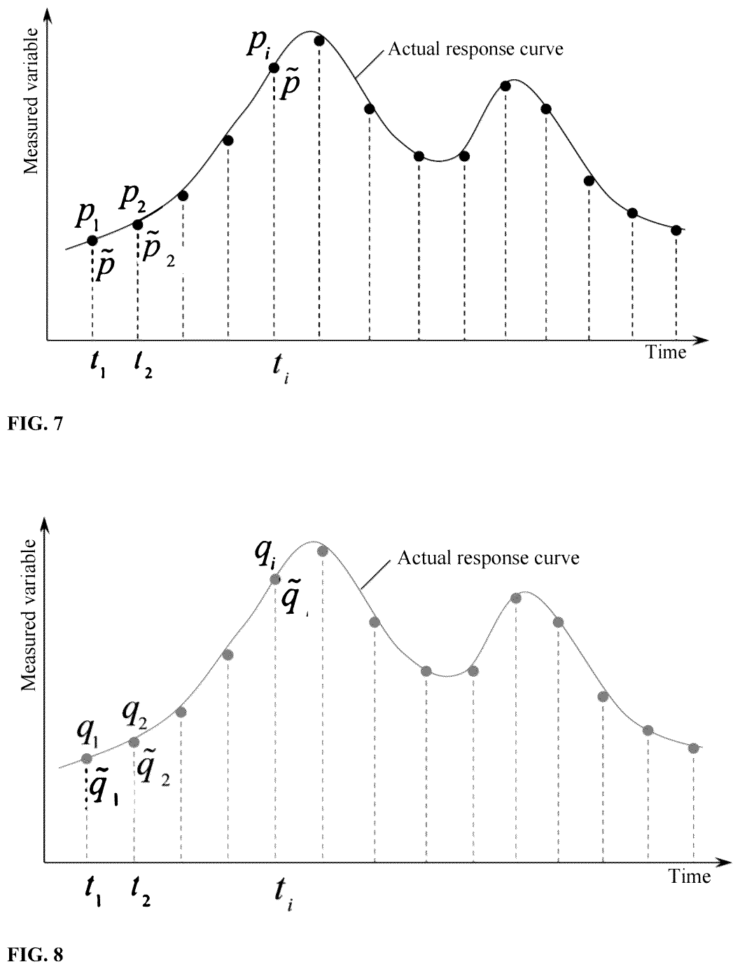

The above measurement process is as shown in FIG. 7 and FIG. 8.

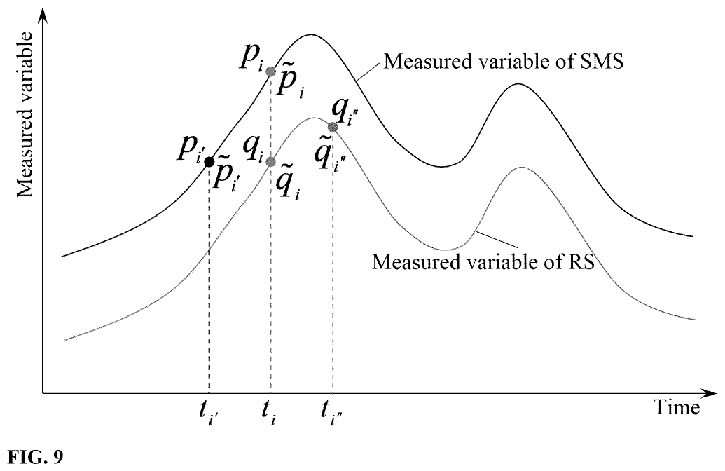

However, in reality, when the spatial distribution of structural strain is not uniform, there will be spatial differences in measured variables due to different mounting locations of the SMS and the RS. Meanwhile, a strictly synchronous measurement is also difficult to implement due to measurement frequency differences and time-lag effects of the two sensors. The time-space differences of the SMS and the RS in the actual measurement process are as shown in FIG. 9.

Taking the ith measurement moment as an example, in FIG. 9, strain values pᵢ and qᵢ of the structure at the mounting location of the SMS and the mounting location of the RS are not exactly the same due to spatial differences. Meanwhile, nominal measurements of the SMS and the RS at the ith measurement moment may be actual measurements of the SMS and the RS at an i′th measurement moment and an i″th measurement moment.

If Δd_{s,i} is denoted as an indication error of the SMS at the ith measurement moment, according to the above analysis, the following equation may be obtained:

$$Δ {d}_{S , i} = {\tilde{p}}_{{i}^{′}} - {p}_{{i}^{′}} = {\tilde{p}}_{i} - ( {p}_{i} + {p}_{t , i} ) \qquad ( 5 )$$

wherein, in the equation, p_{t,i} is a quantity of influence of a measurement time difference of the SMS.

Similarly, if Δd_{R,i} is denoted as an indication error of the RS at the ith measurement moment, the following equation may be obtained:

$$Δ {d}_{R , i} = \text{?} - \text{?} = {\tilde{q}}_{i} - ( {q}_{i} + {q}_{t , i} ) \qquad ( 6 )$$

$$\text{?} \text{indicates text missing or illegible when filed}$$

wherein, in the equation, q_{t,i} is a quantity of influence of a measurement time difference of the RS.

The subtraction of the equations (5) and (6) yields:

$$Δ {d}_{S , i} = Δ {d}_{R , i} + \text{?} - \text{?} + \text{?} - \text{?} + {q}_{t , i} - {p}_{t , i} \qquad ( 7 )$$

$$\text{?} \text{indicates text missing or illegible when filed}$$

If it denotes Δd_{s,i}=\tilde{p}ᵢ−\tilde{q}ᵢ, Δd_{sp,i}=pᵢ−qᵢ, and Δd_{tm,i}=p_{t,i}−q_{t,i}, the equation (7) may be expressed as:

$$Δ {d}_{S , i} = Δ {d}_{R , i} + Δ {d}_{S - R , i} - Δ {d}_{sp , i} - Δ {d}_{tm , i} \qquad ( 8 )$$

wherein, in the equation, Δd_{S-R,i} is a difference between indications measured by the SMS and the RS at the ith measurement moment; Δd_{sp,i} is a difference between actual response values of the structure at the mounting locations of the SMS and the RS, and represents a space difference of actually measured variables; and Δd_{tm,i} is a compensation value for measurement time differences of the SMS and the RS.

It can be known from the equation (8) that when the structural monitoring system is subjected to online calibration during operation, an instantaneous indication error is superposed by the following four elements:
(1) a difference between instantaneous indications of the SMS and the RS;
(2) the indication error of the RS
(3) a difference between actual measured variables at measurement locations of the SMS and the RS; and
(4) a quantity of influence of a difference between measurement frequencies of the SMS and the RS.

Since the measurement result of the strain is closely related to the mounting and tension states of the sensors, RS and SMS need to be at the same level in terms of the measured variable by adjusting the tension of the RS sensor in order to better implement comparison of the measured variables for online calibration. On the other hand, the basic error is calculated by strain sensors being one form of linear displacement sensors, which is an important link for achieving online calibration.

In view of practical application of online calibration, the present disclosure provides a calculation method for two quantitative indices: a period measurement error and a basic error. The period measurement error reflects an overall difference between measured variables of the SMS and the RS, and the basic error is used to characterize the metrological characteristics of the SMS under a passive excitation condition.

A certain moment (ith moment) concerned by an instantaneous measurement error model in the above description is extended to a data analysis cycle for online calibration, and then ambient condition changes, excitation source characteristics and other influence factors need also to be taken into account in addition to the existing items in the equation (8).

Therefore, the present disclosure provides a measurement model for the period measurement error of the SMS during online calibration as follows:

$$Δ {d}_{S} = Δ {d}_{S - R} + Δ {d}_{R} - Δ {d}_{sp} - Δ {d}_{tm} - Δ {d}_{T} + {δ}_{E} \qquad ( 9 )$$

wherein, in the equation, Δdₛ is a representative value of the duration measurement value of the SMS during online calibration; Δd_{S-R} is a representative value of a difference between strain indications of the SMS and the RS during online calibration; Δd_{R} is a representative value of a strain indication error of the RS under similar conditions for online calibration, which is obtained by calibration of a metering mechanism in the previous stage; Δdₛₚ is a quantity of influence of a difference between actual strain values at the mounting locations of the SMS and the RS during online calibration; Δdₜₘ is a quantity of influence of a difference in measurement frequencies of the SMS and the RS during online calibration; Δd_{T} is a quantity of influence of an ambient temperature change on an assessment of the indication error of the SMS during online calibration; and δ_{E} is a quantity of influence of excitation source characteristics and a data transmission process on an assessment of the indication error of the SMS. The above representative values may be determined according to the needs of the metrology performance assessment of a sensing system, for example, can be selected from a maximum value, a mean value, a median, and the like.

In particular, the strain “indication” refers to an amount of change in strain during online calibration, rather than an absolute value of strain relative to an initial mounting state of a sensor.

In the equation (9), Δdₛₚ can be further expressed as:

$$Δ {d}_{s p} = ∇ d \cdot l \qquad ( 10 )$$

wherein, in the equation (10), ∇d is a representative value of an actual strain gradient at mounting regions of the SMS sensor and the RS sensor during online calibration; and l is a mounting distance between the SMS sensor and the RS sensor.

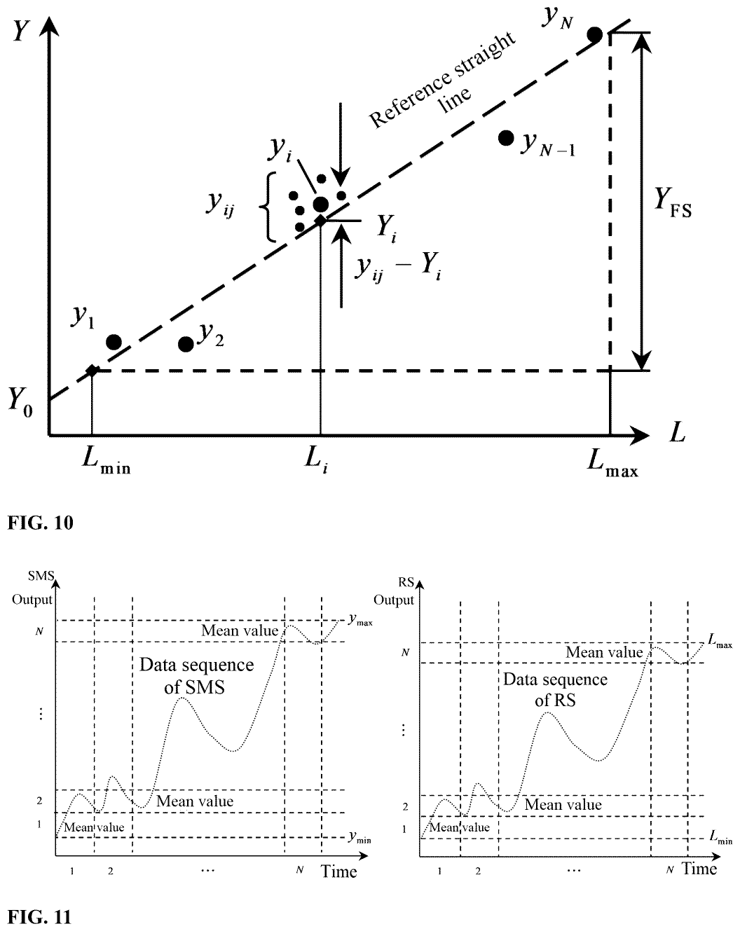

The basic error is an important measuring index for a linear displacement sensor, and a calculation method for the basic error of the linear displacement sensor is provided in the current Calibration Specification for Linear Displacement Sensors (JJF 1305-2011) under laboratory conditions. The method performs measurement in three cycles with a positive stroke and a negative stroke as one cycle, thereby establish a reference straight line equation Yᵢ=Y₀+KLᵢ. Then, referring to a calibration curve in FIG. 10, a largest absolute value in an equation (11) is taken as the basic error.

$${δ}_{ij} = \frac{{y}_{ij} - {Y}_{i}}{{Y}_{F S}} \times 100 \% , i = 1 , 2 , … N \qquad ( 11 )$$

in the equation (11), Y_{FS} is a difference between output values corresponding to a maximum input value Lₘₐₓ and a minimum input value Lₘᵢₙ on a fitted straight line.

The strain measurement data cannot clearly distinguish between the positive stroke and the negative stroke due to the limitation of the passive excitation condition of a passing vehicle. The present disclosure extends the existing calculation method for the basic error, and provides the following method.

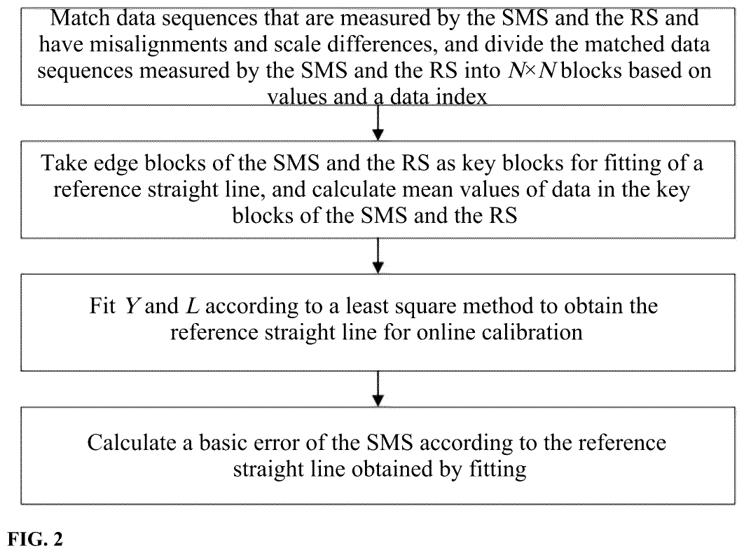

As shown in FIG. 2 and FIG. 11, a matched typical data segment of the SMS and the RS is divided into N×N blocks based on the values and a data index, wherein coordinate locations of blocks in a horizontal axis direction are used to specify a sequential order of data, and coordinate locations of blocks in a vertical axis direction are used to determine calibration points.

Edge blocks of the SMS and the RS are taken as key blocks for fitting of a reference straight line, mean values of data in the key blocks of the SMS and the RS are calculated to correspondingly form data sequences Y=y₁, y₂, . . . , y_{M} and X=x₁, x₂, . . . , x_{M} wherein M is a quantity of the key blocks of the SMS or the key blocks of the RS. Y and L are fitted according to a least square method to obtain a reference straight line for online calibration.

When variables in FIG. 10 are calculated, an increment introduced due to block division needs to be removed. This is due to the fact that during laboratory calibration, yᵢⱼ corresponds to measured variables of the same calibration point (value), whereas, measured variables in a region do not correspond to the same value under the online calibration condition, so that the range of yᵢⱼ is enlarged.

Therefore, in the equation (10), reasonable offsets need to be taken into account in calculation of yᵢⱼ, Yᵢ and Y_{FS}. It is supposed that a maximum value, a minimum value and a mean value of data in an ith edge block in the data segment of the SMS are respectively Y_{max,i}, Y_{min,i} and Y_{mean,i} wherein i=1, 2, . . . , M and M is a quantity of the edge blocks in the data segment of the SMS. For each calibration point, there are an upper edge block and a lower edge block, so M=2N.

If it denotes

$$\begin{matrix}{\overline{Y}}_{max} = \frac{1}{M} {\sum }_{1}^{M} {Y}_{max , i} , {\hat{Y}}_{max} = max ( {Y}_{max , i} ) , \\ {\overline{Y}}_{ofs +} = \frac{1}{M} {{\sum }_{i = 1}}^{M} ( {Y}_{max , i} - {Y}_{mean , i} )\end{matrix} \qquad ( 12 )$$

$$\begin{matrix}{Y}_{min} = \frac{1}{M} {\sum }_{1}^{M} {Y}_{min , i} , {\hat{Y}}_{min} = min ( {Y}_{min , i} ) , \\ {\overline{Y}}_{ofs -} = \frac{1}{M} {{\sum }_{i = 1}}^{M} ( {Y}_{min , i} - {Y}_{mean , i} )\end{matrix} \qquad ( 13 )$$

an increment for a monitoring value of the SMS introduced due to block division is:

$${Y}_{ofs + , i} = \{ \begin{matrix}{\overline{Y}}_{ofs +} \cdot ( {Y}_{max , i} - {\overline{Y}}_{max} ) / ( {\hat{Y}}_{max} - {\overline{Y}}_{max} ) , & {\hat{Y}}_{max} \neq {\overline{Y}}_{max} \\ {\overline{Y}}_{ofs +} , & {\hat{Y}}_{max} = {\overline{Y}}_{max}\end{matrix} \qquad ( 14 )$$

$$or ,$$

$${Y}_{ofs - , i} = \{ \begin{matrix}{\overline{Y}}_{ofs -} \cdot ( {Y}_{min , i} - {\overline{Y}}_{min} ) / ( {\hat{Y}}_{min} - {\overline{Y}}_{min} ) , & {\hat{Y}}_{min} \neq {\overline{Y}}_{min} \\ {\overline{Y}}_{ofs -} , & {\hat{Y}}_{min} = {\overline{Y}}_{min}\end{matrix} \qquad ( 15 )$$

similarly, an increment for a monitoring value of the RS introduced due to block division is:

$${L}_{ofs + , i} = \{ \begin{matrix}{\overline{L}}_{ofs +} \cdot ( {L}_{max , i} - {\overline{L}}_{max} ) / ( {\hat{L}}_{max} - {\overline{L}}_{max} ) , & {\hat{L}}_{max} \neq {\overline{L}}_{max} \\ {\overline{L}}_{ofs +} , & {\hat{L}}_{max} = {\overline{L}}_{max}\end{matrix} \qquad ( 16 )$$

$$or ,$$

$${L}_{ofs - , i} = \{ \begin{matrix}{\overline{L}}_{ofs -} \cdot ( {L}_{min , i} - {\overline{L}}_{min} ) / ( {\hat{L}}_{min} - {\overline{L}}_{min} ) , & {\hat{L}}_{min} \neq {\overline{L}}_{min} \\ {\overline{L}}_{ofs -} , & {\hat{L}}_{min} = {\overline{L}}_{min}\end{matrix} \qquad ( 17 )$$

In the equations (16)˜(17), the symbols relevant to the RS have the same meaning as above.

After correction, the basic error of the structural monitoring system is the largest absolute value in equations (18) and (19):

$$\begin{matrix}{δ}_{i +} = \frac{( {y}_{i +} - {Y}_{ofs + , i} ) - [ {Y}_{0} + K ( {L}_{i +} - {L}_{ofs + , i} ) ]}{{Y}_{FS} + {Y}_{B}} \times 100 \% \\ i = 1 , 2 , … M .\end{matrix} \qquad ( 18 )$$

$$\begin{matrix}{δ}_{i -} = \frac{( {y}_{i -} - {Y}_{ofs - , i} ) - [ {Y}_{0} + K ( {L}_{i -} - {L}_{ofs - , i} ) ]}{{Y}_{FS} + {Y}_{B}} \times 100 \% \\ i = 1 , 2 , … M .\end{matrix} \qquad ( 19 )$$

In the equations, yᵢ₊ and yᵢ₋ are respectively a maximum value and a minimum value in an ith key block of the SMS; Lᵢ₊ and Lᵢ₋ are respectively a maximum value and a minimum value in an ith key block of the RS; and YB is a height of each key block of the SMS.

Since the calculation of the basic error for online calibration depends on complex on-site conditions and the data selection process, the present disclosure introduces the concept of confidence, which is expressed using the half-width of an interval containing a probability P (being 90%˜99%).

It should be noted that the above specific embodiments are merely preferred embodiments of the present disclosure and the principles of the present disclosure. It will be apparent to those skilled in the art that various modifications, equivalents, variations, and the like can be made to the present disclosure. However, such variations are intended to fall within the scope of the present disclosure without departing from the spirit of the present disclosure. In addition, some terms used in the description and claims is not used for limitation and is only for facilitating the description.

What is claimed:

1. A passive excitation-based online calibration method for a bridge structural monitoring system, comprising the following steps:
1) taking a dynamic load of a normal passing vehicle on a bridge as a passive excitation source to act on a bridge structure;
2) acquiring strain data of the bridge structure by an RS (Reference System) and an SMS (Structural Monitoring System) to be calibrated continuously and synchronously, and forming measurement data sequences according to time sequencing;
3) calculating an instantaneous measurement error, a period measurement error and a basic error of the SMS according to the measurement data sequences acquired by the RS and the SMS to be calibrated respectively; and
4) taking the instantaneous measurement error, and/or the period measurement error, and/or the basic error as a calibration basis to perform online calibration on the SMS.

2. The online calibration method for the bridge structural monitoring system according to claim 1, wherein in the step 3), the instantaneous measurement error of the SMS is calculated by an equation (1) below:
$$Δ {d}_{S , i} = Δ {d}_{R , i} + Δ {d}_{S - R i} - Δ {d}_{s p , i} - Δ {d}_{t m , i} \qquad equation ( 1 )$$
in the equation (1), Δd_{S,i} represents the instantaneous measurement error of the SMS in measuring strain of the bridge structure at an ith measurement moment;
Δd_{R,i} represents a measurement indication error of the RS in measuring strain of the bridge structure at the ith measurement moment;
Δd_{S-R,i} represents a difference between measurement indications of the SMS and the RS in measuring strain of the bridge structure at the ith measurement moment;
Δd_{sp,i} represents a difference between actual strain values of the bridge structure at mounting locations of the SMS and the RS on a bridge; and
Δd_{tm,i} represents a compensation value for measurement time differences of the SMS and the RS.

3. The online calibration method for the bridge structural monitoring system according to claim 2, wherein Δd_{R,i} is calculated by an equation (2) below:
$$Δ {d}_{R , i} = {\tilde{q}}_{{i}^{″}} - {q}_{{i}^{″}} = {\tilde{q}}_{i} - ( {q}_{i} + {q}_{t , i} ) \qquad equation ( 2 )$$
in the equation (2), \tilde{q}_{i″} represents a measurement indication of the RS in measuring the strain of the bridge structure at an i″th measurement moment when an actual measurement moment of the ith measurement moment is the i″th measurement moment;
q_{i″} represents an actual strain value of the bridge structure at a mounting location of an RS sensor at the i″th measurement moment;
\tilde{q}ᵢ represents a measurement indication of the RS in measuring the strain of the bridge structure at the ith measurement moment;
qᵢ represents an actual strain value of the bridge structure at the mounting location of the RS sensor at the ith measurement moment; and
q_{t,i} represents a quantity of influence of the measurement time difference of the RS on accuracy of a strain measurement result of the bridge structure.

4. The online calibration method for the bridge structural monitoring system according to claim 2, wherein Δd_{S-R,i} is calculated by an equation (3) below:
$$Δ {d}_{S - R , i} = {\tilde{p}}_{i} - {\tilde{q}}_{t} \qquad equation ( 3 )$$
in the equation (3), \tilde{p}ᵢ represents a measurement indication of the SMS in measuring the strain of the bridge structure at the ith measurement moment; and
\tilde{q}ᵢ represents a measurement indication of the RS in measuring the strain of the bridge structure at the ith measurement moment.

5. The online calibration method for the bridge structural monitoring system according to claim 4, wherein Δd_{sp, i} is calculated by an equation (4) below:
$$Δ {d}_{s p , i} = {p}_{i} - {q}_{i} \qquad equation ( 4 )$$
in the equation (4), pᵢ represents an actual strain value of the bridge structure at a mounting location of an SMS sensor at the ith measurement moment; and
qᵢ represents the actual strain value of the bridge structure at the mounting location of the RS sensor at the ith measurement moment.

6. The online calibration method for the bridge structural monitoring system according to claim 5, wherein Δd_{tm,i} is calculated by an equation (5) below:
$$Δ {d}_{t m , i} = {p}_{t , i} - {q}_{t , i} \qquad equation ( 5 )$$
in the equation (5), p_{t,i} represents a quantity of influence of the measurement time difference of the SMS on the accuracy of the strain measurement result of the bridge structure; and
q_{t,i} represents the quantity of influence of the measurement time difference of the RS on the accuracy of the strain measurement result of the bridge structure.

7. The online calibration method for the bridge structural monitoring system according to claim 1, wherein the period measurement error of the SMS is calculated by an equation (6) below:
$$Δ {d}_{S} = Δ {d}_{S - R} + Δ {d}_{R} - Δ {d}_{s p} - Δ {d}_{t m} - Δ {d}_{T} + {δ}_{E} \qquad equation ( 6 )$$
in the equation (6), Δd_{S} represents the period measurement error of the SMS in measuring the strain of the bridge structure during online calibration;
Δd_{S-R} represents a difference between measurement indications of the SMS and the RS in measuring the strain of the bridge structure during online calibration;
Δd_{R} represents a measurement indication error of the RS in measuring the strain of the bridge structure during online calibration;
Δdₛₚ represents a difference between actual strain values of the bridge structure at the mounting locations of the SMS sensor and the RS sensor on the bridge;
Δdₜₘ represents a compensation value for the measurement time differences of the SMS and the RS during online calibration;
Δd_{T} represents a quantity of influence of an ambient temperature change on an assessment of a strain measurement indication error of the SMS during online calibration; and
δ_{E} represents a quantity of influence of excitation source characteristics and a data transmission process on an assessment of the strain measurement indication error of the SMS.

8. The online calibration method for the bridge structural monitoring system according to claim 7, wherein Δdₛₚ is calculated by an equation (7) below:
$$Δ {d}_{s p} = ∇ d \cdot l \qquad equation ( 7 )$$
in the equation (7), ∇_{d} represents an actual strain gradient at mounting regions of the SMS sensor and the RS sensor during online calibration; and
l represents a mounting distance between the SMS sensor and the RS sensor.

9. The online calibration method for the bridge structural monitoring system according to claim 1, wherein in the step 3), a method step of calculating the basic error comprises:
3.1) matching data sequences that are measured by the SMS and the RS and have misalignments and scale differences, dividing the matched data sequences formed by measurement of the SMS and the RS into N×N blocks based on measured values and a data index, wherein coordinate locations of the blocks in a horizontal axis direction are used to specify a sequential order of data, and coordinate locations of the blocks in a vertical axis direction are used to determine calibration points;
3.2) taking edge blocks of the SMS and the RS as key blocks for fitting of a reference straight line, calculating mean values of data in the key blocks of the SMS and the RS to correspondingly form data sequences Y=y₁, y₂, . . . , Y_{M} and X=x₁, x₂, . . . , x_{M}, wherein M represents a quantity of the key blocks of the SMS or the key blocks of the RS;
3.3) fitting Y and L according to a least square method to obtain the reference straight line for online calibration;
3.4) according to the reference straight line fitted in the step 3.3), taking a largest absolute value in an equation (8) or an equation (9) below as the basic error:
$$\begin{matrix}{δ}_{i +} = \frac{( {y}_{i +} - {Y}_{ofs + , i} ) - [ {Y}_{0} + K ( {L}_{i +} - {L}_{ofs + , i} ) ]}{{Y}_{FS} + {Y}_{B}} \times 100 \% \\ i = 1 , 2 , … M\end{matrix} \qquad ( 18 )$$
$$\begin{matrix}{δ}_{i -} = \frac{( {y}_{i -} - {Y}_{ofs - , i} ) - [ {Y}_{0} + K ( {L}_{i -} - {L}_{ofs - , i} ) ]}{{Y}_{FS} + {Y}_{B}} \times 100 \% \\ i = 1 , 2 , … M\end{matrix} \qquad ( 19 )$$
wherein in the equation (8) or the equation (9), δᵢ₊ or δᵢ₋ represents the basic error;
yᵢ₊ and yᵢ₋ are respectively represent a maximum value and a minimum value of data in an ith key block in the key blocks of the SMS;
Lᵢ₊ and Lᵢ₋ are respectively represent a maximum value and a minimum value of data in an ith key block in the key blocks of the RS;
Y_{B} represents a height of each key block of the SMS;
K represents a constant;
Y_{FS} represents a difference between output values corresponding to a maximum input value and a minimum input value on the reference straight line;
Y_{ofs+,i} or Y_{ofs-,i} represents an increment for a monitoring value of the SMS introduced due to block division; and
L_{ofs+,i} or L_{ofs-,i} represents an increment for a monitoring value of the RS introduced due to block division.

10. The online calibration method for the bridge structural monitoring system according to claim 9, wherein
Y_{ofs+,i} is calculated by an equation (10) below:
$${Y}_{ofs + , i} = \{ \begin{matrix}{\overline{Y}}_{ofs +} \cdot \frac{( {Y}_{max , i} - {\overline{Y}}_{max} )}{( {\hat{Y}}_{max} - {\overline{Y}}_{max} )} , & {\hat{Y}}_{max} \neq {\overline{Y}}_{max} \\ {\overline{Y}}_{ofs +} , & {\hat{Y}}_{max} = {\overline{Y}}_{max}\end{matrix} \qquad equation ( 10 )$$
Y_{ofs-,i} is calculated by an equation (11) below:
$${Y}_{ofs - , i} = \{ \begin{matrix}{\overline{Y}}_{ofs -} \cdot \frac{( {Y}_{min , i} - {\overline{Y}}_{min} )}{( {\overline{Y}}_{min} - {\overline{Y}}_{min} )} , {\hat{Y}}_{min} \neq {\overline{Y}}_{min} \\ {\overline{Y}}_{ofs -} , {\hat{Y}}_{min} = {\overline{Y}}_{min}\end{matrix} \qquad equation ( 11 )$$
Y̅_{ofs+} in the equation (10) is calculated by an equation (12) below:
$${\overline{Y}}_{ofs +} = \frac{1}{M} {\sum }_{i = 1}^{M} ( {Y}_{max , i} - {Y}_{m e a n , i} ) \qquad equation ( 12 )$$
Y̅_{ofs-} in the equation (11) is calculated by an equation (13) below:
$${\overline{Y}}_{ofs -} = \frac{1}{M} {\sum }_{i = 1}^{M} ( {Y}_{min , i} - {Y}_{m e a n , i} ) \qquad equation ( 13 )$$
Y̅ₘₐₓ in the equation (10) is calculated by an equation (14) below:
$${\overline{Y}}_{max} = \frac{1}{M} {\sum }_{i = 1}^{M} {Y}_{max , i} \qquad equation ( 14 )$$
Ŷₘₐₓ is calculated by an equation (15) below:
$${\hat{Y}}_{max} = max ( {Y}_{max , i} ) \qquad equation ( 15 )$$
Y̅ₘᵢₙ in the equation (11) is calculated by an equation (16) below:
$${\overline{Y}}_{min} = \frac{1}{M} {\sum }_{i = 1}^{M} {Y}_{min , i} \qquad equation ( 16 )$$
Ŷₘᵢₙ is calculated by an equation (17) below:
$${\hat{Y}}_{min} = min ( {Y}_{min , i} ) \qquad equation ( 17 )$$
Y_{max,i} in the equations (10)-(17) represents a maximum value of the data in the ith key block of the SMS;
Y_{min,i} represents a minimum value of the data in the ith key block of the SMS;
Y_{mean,i} represents a mean value of the data in the ith key block of the SMS;
L_{ofs+,i} is calculated by an equation (18) below:
$${L}_{ofs + , i} = \{ \begin{matrix}{\overline{L}}_{o f s +} \cdot \frac{( {L}_{max , i} - {\overline{L}}_{max} )}{( {\overline{L}}_{max} - {\overline{L}}_{max} )} , & {\hat{L}}_{max} \neq {\overline{L}}_{max} \\ {\overline{L}}_{ofs +} , & {\hat{L}}_{max} = {\overline{L}}_{max}\end{matrix} \qquad equation ( 18 )$$
L_{ofs-,i} is calculated by an equation (19) below:
$${L}_{ofs - , i} = \{ \begin{matrix}{\overline{L}}_{ofs -} \cdot \frac{( {L}_{min , i} - {\overline{L}}_{min} )}{( {\overline{L}}_{min} - {\overline{L}}_{min} )} , & {\hat{L}}_{min} \neq {\overline{L}}_{min} \\ {\overline{L}}_{ofs -} , & {\hat{L}}_{min} = {\overline{L}}_{min}\end{matrix} \qquad equation ( 19 )$$
L̅_{ofs+} in the equation (18) is calculated by an equation (20) below:
$${\overline{L}}_{ofs +} = \frac{1}{M} {\sum }_{i = 1}^{M} ( {L}_{max , i} - {L}_{m e a n , i} ) \qquad equation ( 20 )$$
L̅_{ofs-} in the equation (19) is calculated by an equation (21) below:
$${\overline{L}}_{ofs -} = \frac{1}{M} {\sum }_{i = 1}^{M} ( {L}_{min , i} - {L}_{m e a n , i} ) \qquad equation ( 21 )$$
L̅ₘₐₓ in the equation (18) is calculated by an equation (22) below:
$${\overline{L}}_{max} = \frac{1}{M} {\sum }_{i = 1}^{M} {L}_{max , i} \qquad equation ( 22 )$$
\hat{L}ₘₐₓ is calculated by an equation (23) below:
$${\hat{L}}_{max} = max ( {L}_{max , i} ) \qquad equation ( 23 )$$
L̅ₘᵢₙ in the equation (19) is calculated by an equation (24) below:
$${\overline{L}}_{min} = \frac{1}{M} {\sum }_{i = 1}^{M} {L}_{min , i} \qquad equation ( 24 )$$
\hat{L}ₘᵢₙ is calculated by an equation (25) below:
$${\hat{L}}_{min} = min ( {L}_{min , i} ) \qquad equation ( 25 )$$
L_{max,i} in the equations (18)-(25) represents a maximum value of the data in the ith key block of the RS;
L_{min,i} represents a minimum value of the data in the ith key block of the RS; and
L_{mean,i} represents a mean value of the data in the ith key block of the RS.
